(19) United States
(12) Patent Application Publication
(10) Pub. No.: US 2003/0210839 A1
(43) Pub. Date: Nov. 13, 2003

(54) All-plastic rotary thrust bearing assembly

(76) Inventors: Anatoly Gosis, Palatine, IL (US); Jacques Dhelens, L'Isle Adam (FR); James P. Nelson, Naperville, IL (US)

Correspondence Address: Paul F. Donovan, Patent Department, Illinois Tool Works Inc., 3600 West Lake Avenue, Glenview, IL, 60025, US

(21) Appl. No.: 10/144,150

(22) Filed: May 10, 2002

(51) Int. Cl. F16C 17/04

(52) U.S. Cl. 384/420

(57) ABSTRACT

A rotary thrust bearing assembly wherein, in lieu of a conventional bearing race and ball bearing assembly, a first embodiment of the bearing assembly of the present invention comprises a pair of bearing housings which are fabricated from dissimilar plastic materials such that the bearing housings are adapted to undergo limited pivotal or rotational movement with respect to each other along rotary planar surfaces. In accordance with a second embodiment of the bearing assembly of the present invention, the pair of plastic bearing housings are fabricated from similar plastic materials while an insert, fabricated from a plastic material dissimilar from the plastic material comprising the pair of plastic bearing housings, is interposed between the pair of plastic bearing housings. In this manner, the pair of plastic bearing housings are rotatable with respect to each other along two parallel rotary planar surfaces.

### FIELD OF THE INVENTION

The present invention relates generally to thrust bearing assemblies, and more particularly to a new and improved rotary thrust bearing assembly which comprises a significantly simplified structure embodying a substantially minimum number of component parts and which is nevertheless capable of serving as a rotary thrust bearing assembly for facilitating the relative rotary movement between two load bearing components, particularly wherein such relative rotary movement encompasses relative angular movement which is substantially less than a complete revolution or 360°.

### BACKGROUND OF THE INVENTION

Rotary thrust bearing assemblies, in particular, automotive suspension strut rotary thrust bearing assemblies, are of course well known in the art as exemplified by means of U.S. Pat. No. 6,296,396 which issued on Oct. 2, 2001 to Schwarzbich, U.S. Pat. No. 6,267,512 which issued on Jul. 31, 2001 to Beghini et al., U.S. Pat. No. 5,618,116 which issued on Apr. 8, 1997 to Ishikawa, U.S. Pat. No. 4,995,737 which issued on Feb. 26, 1991 to Moller et al., U.S. Pat. No. 4,925,323 which issued oh May 15, 1990 to Lederman, U.S. Pat. No. 4,822,183 which issued on Apr. 18, 1989 to Lederman, U.S. Pat. No. 4,780,005 which issued on Oct. 25, 1988 to Toyoshima et al., U.S. Pat. No. 4,566,812 which issued on Jan. 28, 1986 to Takei et al., U.S. Pat. No. 4,541,744 which issued on Sep. 17, 1985 to Lederman, U.S. Pat. No. 4,400,041 which issued on Aug. 23, 1983 to Lederman, and U.S. Pat. No. 4,120,543 which issued on Oct. 17, 1978 to Greene, Jr. et al. More particularly, a typical or conventional prior art rotary thrust bearing assembly, which may for example comprise an automotive suspension strut rotary bearing assembly, is disclosed within FIG. 1 and is generally designated by means of the reference character 10.

As can readily be appreciated, the PRIOR ART rotary thrust bearing assembly 10 is seen to include an upper bearing housing 12 which comprises an annular structure which is substantially circumferentially symmetrical with respect to a vertical axis 14 and which is adapted to be operatively connected to a first load transmitting member, not shown, and a lower bearing housing 16 which likewise comprises an annular structure which is substantially circumferentially symmetrical with respect to the vertical axis 14. The lower bearing housing 16 also has a through-bore 18 defined therein which is characterized by means of a vertically inclined axis 20, and it is further noted that the lower bearing housing 16 is adapted to be operatively connected to a second load transmitting member, also not shown. In accordance with the typical or conventional PRIOR ART rotary thrust bearing assembly such as that shown at 10 in FIG. 1a, the upper bearing housing 12 is provided with an upper bearing race member 22, and the lower bearing housing 16 is similarly provided with a lower bearing race member 24, the upper and lower bearing race members 22,24 operatively cooperating together so as to define the external portions of the bearing assembly 10. More particularly, the upper and lower bearing race members 22,24 together define a space therebetween within which a cage or separator, not shown, is adapted to be disposed for, in turn, housing a plurality of ball bearings 26. Accordingly, the bearing assembly 10, which therefore comprises the upper and lower bearing race members 22,24, the cage or separator, not shown, and the ball bearing members 26, enables the upper and lower bearing housings 12,16, and the load transmitting members, not shown, operatively connected thereto, to freely rotate with respect to each other. The upper and lower bearing housings 12,16 are adapted to be effectively joined together by means of suitable, peripherally located snap-fitting lip structures 23,25.

In conjunction with the aforenoted bearing assembly 10, it is further seen that the automotive suspension strut rotary thrust bearing assembly 10 comprises labyrinth seal structure in order to effectively prevent dust and any other debris or contaminants, which may be encountered during driving upon streets or roadways, from entering and fouling the automotive suspension strut rotary thrust bearing assembly 10. More particularly, it is seen that the upper bearing housing 12 has a first peripheral set of downwardly dependent annular ribs members 28,30 which are located radially outwardly with respect to the upper and lower bearing race members 22,24 and which are radially spaced from each other so as to define a first radially outer annular space 32 therebetween, and a second set of downwardly dependent annular ribs members 34,36 which are located radially inwardly with respect to the upper and lower bearing race members 22,24 and which are also radially spaced from each other so as to define a second radially inner annular space 38 therebetween. In a similar manner, the lower bearing housing 16 has a first peripheral set of upwardly projecting annular ribs members 40,42 which are located radially outwardly with respect to the upper and lower bearing race members 22,24 and which are radially spaced from each other so as to define a first radially outer annular space 44 therebetween, and a second set of upwardly projecting annular ribs members 46,48 which are located radially inwardly with respect to the upper and lower bearing race members 22, 24 and which are also radially spaced from each other so as to define a second radially inner annular space 50 therebetween.

The radially outer upstanding annular rib member 40 of the first radially outer set of upstanding annular rib members 40,42 of the lower bearing housing 16 is thus disposed within the annular space 32 defined between the first radially outer set of downwardly dependent annular rib members 28,30 of the upper bearing housing 12, while the radially inner downwardly dependent annular rib member 30 of the first radially outer set of downwardly projecting annular rib members 28,30 of the upper bearing housing 12 is thus disposed within the annular space 44 defined between the first radially outer set of upwardly projecting annular rib members 40,42 of the lower bearing housing 16. In a similar manner, the radially outer downwardly dependent annular rib member 34 of the second radially inner set of downwardly projecting annular rib members 34,36 of the upper bearing housing 12 is thus disposed within the annular space 50 defined between the second radially inner set of upwardly projecting annular rib members 46,48 of the lower bearing housing 16, and the radially inner upstanding annular rib member 48 of the second radially inner set of upstanding annular rib members 46,48 of the lower bearing housing 16 is thus disposed within the annular space 38 defined between the second radially inner set of downwardly dependent annular ribs members 34,36 of the upper bearing housing 12. Accordingly, the rib members 28,40,30,42, as well as the rib members 46,34,48,36, together define radially outer and radially inner interdigitated structural sets of labyrinth seals which effectively protect the ball bearing assemblies from becoming fouled by external debris and contaminants.

While the aforenoted structure characteristic of a typical or conventional PRIOR ART rotary thrust bearing assembly has of course proven to be quite satisfactory over many years of usage within the industry, from an operational point of view, several operational disadvantages or drawbacks have nevertheless also been observed or experienced. For example, it often occurs in connection with such automotive suspension strut rotary thrust bearing assemblies that the various components of the bearing assembly do not always undergo full or complete revolutionary movements, that is, revolutionary movements encompassing at least 360°. More particularly, the components of the bearing assembly will often experience or undergo relative arcuate or angular movements on the order of only 30°. In view of the fact that each ball bearing component engages each one of the upper and lower bearing race members in such a manner that a point-to-surface contact or interface, as opposed to a surface-to-surface interface, is effectively created, what occurs over time is known as the Brinell effect.

As is known from the basic physics formula P=F/A, P represents pressure, or in this case, contact stress, F represents the force or weight, and A represents the contact area upon which the force or weight is acting or impressed. In conjunction with an automotive strut assembly, each ball bearing member of the bearing assembly will support a proportional amount of the vehicle weight over an extremely small contact area whereby an extremely high pressure or contact stress, as measured in psi, will be exerted upon the bearing race members. Since such pressure or contact stress is substantially greater than the resistance or contact strength of the bearing race members, the material comprising the bearing race members tries to accommodate such extreme contact stress or pressure by effectively enlarging the contact area so as to in turn effectively reduce the contact stress. The result is that in accordance with the Brinell effect, the ball bearing members cause indentations, grooves, ruts, or the like, to effectively be etched or otherwise formed within the upper and lower bearing race members in a non-uniform manner, that is, over an angular extent or range of only 30°, whereby the upper and lower bearing races experience an inordinate amount of wear.

A need therefore exists in the art for a new and improved rotary thrust bearing assembly, and in particular, a new and improved automotive suspension strut rotary thrust bearing assembly, wherein the entire ball bearing type rotary thrust bearing assembly, comprising the upper and lower bearing race members, the cage or separator component, and the ball bearing members, can be eliminated, and in lieu thereof, there can be provided an all plastic rotary thrust bearing assembly wherein surface-to-surface contact interfaces are effectively defined between the relatively rotating component parts. In view of the fact that the point-to-surface contact or interface between the relatively rotating component parts has effectively been eliminated, and that the surface-to-surface contact or interface between the relatively rotating components parts has effectively been established, the relatively rotating component parts will not experience an inordinate amount of wear.

### OBJECTS OF THE INVENTION

Accordingly, it is an object of the present invention to provide a new and improved rotary thrust bearing assembly, and in particular, a new and improved automotive suspension strut rotary thrust bearing assembly.

Another object of the present invention is to provide a new and improved rotary thrust bearing assembly, and in particular, a new and improved automotive suspension strut rotary thrust bearing assembly, wherein the various operational disadvantages and drawbacks, characteristic of PRIOR ART rotary thrust bearing assemblies, are effectively overcome.

An additional object of the present invention is to provide a new and improved rotary thrust bearing assembly, and in particular, a new and improved automotive suspension strut rotary thrust bearing assembly, wherein the point-to-surface contact or interface, defined between the relatively rotating component parts of the bearing assembly, is effectively eliminated.

A further object of the present invention is to provide a new and improved rotary thrust bearing assembly, and in particular, a new and improved automotive suspension strut rotary thrust bearing assembly, wherein the point-to-surface contact or interface, defined between the relatively rotating component parts of the bearing assembly, is effectively eliminated so as not to cause an inordinate amount of non-uniform wear of the bearing assembly components, and a surface-to-surface contact or inter-face is established between the relatively rotating component parts so as to effectively enhance the wear properties of the bearing assembly components.

A last object of the present invention is to provide a new and improved rotary thrust bearing assembly, and in particular, a new and improved automotive suspension strut rotary thrust bearing assembly, wherein the multiple components of a typical, PRIOR ART, ball bearing assembly, comprising the upper and lower bearing races, the cage or separator, and the multiplicity of ball bearing members, are able to be eliminated and replaced by means of a simplified two-piece or three-piece structural assembly.

### SUMMARY OF TEE INVENTION

The foregoing and other objectives are achieved in accordance with the teachings and principles of the present invention through the provision of a new and improved rotary thrust bearing assembly, and in particular, a new and improved automotive suspension strut rotary thrust bearing assembly, which, in accordance with the teachings and principles of a first embodiment of the present invention, comprises first and second upper and lower bearing housings which are fabricated from suitable dissimilar plastic or resin materials. The upper bearing housing comprises a lower annular planar bearing surface, and the lower bearing housing comprises an upper annular planar bearing surface disposed in contact with the lower annular planar bearing surface of the upper bearing housing, and in this manner, a surface-to-surface contact, engagement, or interface is defined between the upper and lower bearing housings. In accordance with the principles and teachings of a second embodiment of the present invention, the upper and lower bearing housings are fabricated from similar or identical resin or plastic materials and are operatively separated by means of a bearing insert, which is fabricated from a resin or plastic material which is dissimilar to the material from which the upper and lower bearing housings are fabricated, which is interposed between the lower annular planar bearing surface of the upper bearing housing and the upper annular planar bearing surface of the lower bearing housing. In this manner, a pair of annular planar bearing interfaces are effectively established between the lower annular planar bearing surface of the upper bearing housing and the upper annular planar bearing surface of the bearing insert, and between the upper annular planar bearing surface of the lower bearing housing and the lower annular planar bearing surface of the bearing insert, respectively.

It can thus be appreciated that the multiplicity of components characteristic of a conventional PRIOR ART rotary thrust bearing assembly has effectively been eliminated. In addition, the point-to-surface contact or interface as conventionally established or established between the ball bearing members and the upper and lower ball bearing races have also been effectively eliminated and replaced by means of surface-to-surface contact bearing members. Accordingly, enhanced service life of the bearing assembly is effectively provided.

### BRIEF DESCRIPTION OF THE DRAWINGS

Various other objects, features, and attendant advantages of the present invention will be more fully appreciated from the following detailed description when considered in connection with the accompanying drawings in which like reference characters designate like or corresponding parts throughout the several views, and wherein:

FIG. 1 is a cross-sectional view of a conventional PRIOR ART automotive suspension strut rotary thrust ball bearing assembly;

FIG. 2 is a cross-sectional view corresponding or similar to the cross-sectional view of FIG. 1 showing, however, in lieu of the PRIOR ART automotive suspension strut rotary thrust ball bearing assembly, a first embodiment of a new and improved automotive suspension strut rotary thrust bearing assembly constructed in accordance with the principles and teachings of the present invention; and

FIG. 3 is a cross-sectional view illustrating a second embodiment of a new and improved rotary thrust bearing assembly constructed in accordance with the principles and teachings of the present invention.

### DETAILED DESCRIPTION OF THE PREFERRED EMBODIMENT

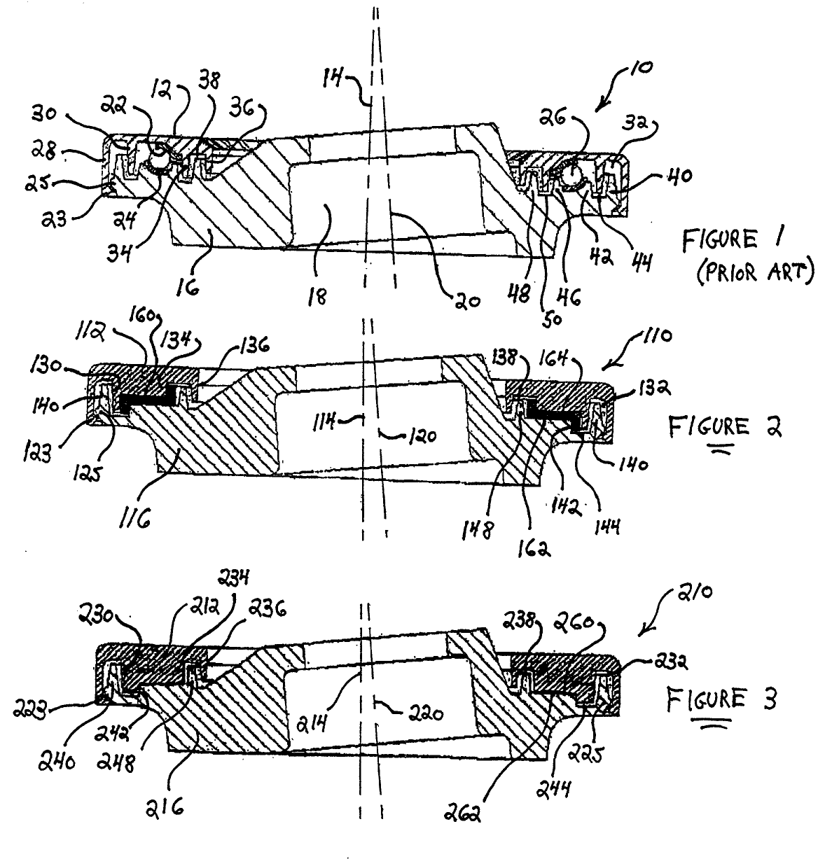

Referring now to the drawings, and more particularly to FIG. 2 thereof, a first embodiment of a new and improved automotive suspension strut rotary thrust bearing assembly, constructed in accordance with the principles and teachings of the present invention, is disclosed and is generally indicated by the reference character 110. It is noted that the automotive suspension strut rotary thrust bearing assembly 110 as illustrated in FIG. 2 is quite similar to the conventional PRIOR ART automotive suspension strut rotary thrust bearing assembly 10 as illustrated in FIG. 1, except as will be noted more specifically hereinafter, and accordingly, component parts of the automotive suspension strut rotary thrust bearing assembly 110 which correspond to the component parts of the automotive suspension strut rotary thrust bearing assembly 10 will not be discussed in detail but will be designated by means of corresponding reference characters except that the reference characters will be within the 100 series. More particularly, it is seen that the new and improved automotive suspension strut rotary thrust bearing assembly 110 is seen to comprise an upper bearing housing 112 and a lower bearing housing 116 which are adapted to be secured together by means of the peripheral snap-fitting portions 123,125.

In accordance with the principles and teachings of the present invention, it is further seen that the upper and lower bearing race members 22,24, as well as the operatively associated cage or separator and the plurality of ball bearing members, not shown, have been eliminated, and in lieu thereof, the annular lower interior surface portion of the upper bearing housing 112, which is interposed between the downwardly dependent annular rib members 130,134, has been modified so as to effectively provide or define a first annular planar bearing surface 160 which is recessed within the upper bearing housing 112, while in a similar manner, the annular upper interior surface portion of the lower bearing housing 116, which is interposed between the upwardly extending annular rib members 142,148, has likewise been modified so as to provide or define a second annular planar bearing surface 162 which is vertically spaced from the first annular planar bearing surface 160. Furthermore, in accordance with the principles and teachings of the present invention, an annular bearing insert 164 is interposed between the vertically spaced first and second planar bearing surfaces 160,162 and is disposed within the recessed portion of the upper bearing housing 112 such that first and second bearing planes are respectively defined between the annular lower interior surface portion of the upper bearing housing 112 and the upper surface portion of the annular bearing insert 164, and between the annular upper interior surface portion of the lower bearing housing 116 and the lower surface portion of the annular bearing insert 164.

It can therefore be readily appreciated that as the upper and lower bearing housings 112,116 rotate with respect to each other, as a result of being fixedly connected to their respective components of the automotive suspension strut system, the relative rotary movement of the upper and lower bearing housings 112,116 is facilitated by means of the aforenoted first and second bearing planes respectively defined between the first and second planar bearing surfaces 160,162 of the upper and lower bearing housings 112,116 and the bearing insert 164. It can therefore be readily appreciated that as a result of providing or defining a surface-to-surface contact rotary thrust bearing assembly, the operational disadvantages and drawbacks, such as, for example, the Brinell effect characteristic of the PRIOR ART system 10 as disclosed within FIG. 1, are effectively overcome.

In connection with the fabrication of the upper and lower bearing housings 112,116 and the bearing insert 164, both of the upper and lower bearing housings 112,116 are preferably fabricated from the same thermoplastic or resin material, whereas the bearing insert 164 is preferably fabricated from a thermoplastic or resin material which is different from the particular thermoplastic or resin material used to fabricate the upper and lower bearing housings 112,116. Examples of suitable thermoplastic or resin materials which may be selected in order to fabricate the upper and lower bearing housings 112,116 may comprise NYLON®, a suitable acetate, an ultra-high molecular weight (UHMW) polyethylene, a suitable polycarbonate, a suitable polyamide, a suitable polypropylene, a suitable polyester, and the like. In a similar manner, the bearing insert 164 may be fabricated from polytetrafluoroethyelene (TEFLON®), a suitable thermoplastic or resin material containing ceramic particles, or the like. As a result of the fabrication of the aforenoted upper and lower bearing housings 112,116, as well as the bearing insert 164, from a suitable combination of the aforenoted thermoplastic or resin materials, a predetermined amount or degree of lubricity, abrasion resistance, impact shock resistance, and similar properties, are imparted to the upper and lower bearing housings 112,116 and the bearing insert 164 so as to in fact enable the desirable achievement of the rotary movement of the upper and lower bearing housings 112,116, and the automotive suspension strut components operatively connected thereto, with respect to each other.

With reference now being made to FIG. 3, a second embodiment of a new and improved rotary thrust bearing assembly, which is similar to the first embodiment of the automotive suspension strut rotary thrust bearing assembly 110 as disclosed within FIG. 2 and which can likewise constitute an automotive suspension strut rotary thrust bearing assembly, has likewise been constructed in accordance with the principles and teachings of the present invention and is disclosed by means of the reference character 210. It is noted that the rotary thrust bearing assembly 210 as illustrated in FIG. 3 is quite similar to the automotive suspension strut rotary thrust bearing assembly 110 as illustrated in FIG. 2, except as will be specifically noted hereinafter, and accordingly, component parts of the rotary thrust bearing assembly 210, which correspond to the component parts of the automotive suspension strut rotary thrust bearing assembly 110, will not be discussed in detail but will be designated by means of corresponding reference characters except that the reference characters will be within the 200 series. More particularly, it is seen that the new and improved rotary thrust bearing assembly 210 is seen to comprise an upper bearing housing 212 and a lower bearing housing 216 which are adapted to be secured together by means of the peripheral snap-fitting portions 223,225, however, it is noted that the primary difference between the first and second embodiments of the rotary thrust bearing assemblies 110,210 of the present invention, as respectively disclosed within FIGS. 2 and 3, resides in the fact that in accordance with the principles and teachings of the present invention, the bearing insert component 164 of the first embodiment rotary thrust bearing assembly 110 has been eliminated.

More particularly, the upper planar bearing surface 260 of the upper bearing housing 212 is effectively defined or disposed within an annular recessed portion of the upper bearing housing 212 and is adapted to be disposed in direct contact with the lower planar bearing surface 262 which is similarly defined or disposed within an annular recessed portion of the lower bearing housing 216. It can therefore be readily appreciated that the upper planar bearing surface 260 of the upper bearing housing 212 is disposed in surface-to-surface contact or engagement with the lower planar bearing surface 262 of the lower bearing housing 216 such that the bearing surfaces 260,262 together define a bearing plane along which the first and second bearing housings 212,216 are able to undergo relative rotary movement. In addition, in view of the fact that the bearing insert component has been eliminated and that the rotary thrust bearing assembly 210 only comprises in effect a two-component bearing system or assembly, as opposed to the three-component bearing system or assembly 110 of FIG. 2, the upper and lower bearing housings 212, 216 are preferably fabricated from different thermoplastic or resin materials, although the particular materials may nevertheless still be selected from the aforenoted examples of thermoplastic or resin materials. It can therefore be appreciated that, as was the case with the first embodiment of the rotary thrust bearing assembly of the present invention as illustrated within FIG. 2, as a result of the fabrication of the aforenoted upper and lower bearing housings 212,216 from a suitable combination of the aforenoted thermoplastic or resin materials, a predetermined amount or degree of lubricity, abrasion resistance, impact shock resistance, and similar properties, are imparted to the upper and lower bearing housings 212,216 so as to in fact enable the desirable achievement of the rotary movement of the upper and lower bearing housings 212, 216, and the automotive suspension strut components operatively connected thereto, with respect to each other. In addition, and again, as was the case with the first embodiment of the rotary thrust bearing assembly of the present invention as illustrated within FIG. 2, as a result of providing or defining a surface-to-surface contact rotary thrust bearing assembly, the operational disadvantages and drawbacks, such as, for example, the Brinell effect characteristic of the PRIOR ART system 10 as disclosed within FIG. 1, are effectively overcome.

Thus, it may be seen that in accordance with the principles and teachings of the present invention, there has been provided a new and improved rotary thrust bearing assembly wherein the assembly comprises bearing members or components which define bearing surfaces which are planar such that the rotary movements of the upper and lower bearing housings with respect to each other are facilitated or supported by means of bearing surfaces which are disposed in surface-to-surface contact or engagement with respect to each other. In this manner, the aforenoted gouging, indenting, or etching of the ball bearing race members by means of the ball bearing members, as determined by means of the point-to-surface contact or engagement between the ball bearing members and the ball bearing race members, during limited arcuate or angular movement of the upper and lower bearing housings, is effectively overcome and eliminated. It is further noted that the attributes of the present invention are of course able to be achieved whether the rotary thrust bearing assembly comprises an automotive suspension strut rotary thrust bearing assembly, or a rotary thrust bearing assembly which can be utilized within environments or technologies other than in automotive suspension strut assemblies, and still further, whether the rotary thrust bearing assembly comprises a three-component rotary thrust bearing assembly or a two-component rotary thrust bearing assembly.

obviously, many variations and modifications of the present invention are possible in light of the above teachings. It is therefore to be understood that within the scope of the appended claims, the present invention may be practiced otherwise than as specifically described herein.

What is claimed as new and desired to be protected by Letters Patent of the United States of America, is:

1. An automotive suspension strut rotary thrust bearing assembly, comprising:
a first bearing housing adapted to be connected to a first automotive suspension strut component, fabricated from a first plastic material, and defining a first substantially planar bearing surface;
a second bearing housing adapted to be connected to a second automotive suspension strut component, fabricated from a second plastic material, and defining a second substantially planar bearing surface; and
a bearing insert fabricated from a third plastic material which is different from said first and second plastic, interposed between said first and second bearing surfaces of said first and second bearing housings, and comprising first and second substantially planar bearing surfaces so as to respectively define first and second bearing planes between said first planar bearing surfaces of said first bearing housing and said bearing insert, and between said second planar bearing surfaces of said second bearing housing and said bearing insert for facilitating rotational movement of said first and second bearing housings with respect to each other.

2. The rotary thrust bearing assembly as set forth in claim 1, wherein:
said first planar bearing surfaces of said first bearing housing and said bearing insert are disposed in surface-to-surface contact with each other along said first bearing plane, and said second planar bearing surfaces of said second bearing housing and said bearing insert are disposed in surface-to-surface contact with each other along said second bearing plane.

3. The rotary thrust bearing assembly as set forth in claim 1, wherein:
said first and second bearing planes are disposed substantially parallel with respect to each other.

4. The rotary thrust bearing assembly as set forth in Claim 1, wherein:
said first bearing housing has a recessed portion defined therein; and
said bearing insert is disposed within said recessed portion of said first bearing housing.

5. The rotary thrust bearing assembly as set forth in claim 1, wherein:
said first and second plastic materials, from which said first and second bearing housings are fabricated, are the same.

6. The rotary thrust bearing assembly as set forth in claim 5, wherein:
said plastic material, from which both of said first and second bearing housings are fabricated, is selected from the group of plastic materials comprising NYLON®, an acetate, an ultra-high molecular weight (UHMW) polyethylene, a polycarbonate, a polyamide, a polypropylene, and a polyester.

7. The rotary thrust bearing assembly as set forth in claim 5, wherein:
said third plastic material, from which said bearing insert is fabricated, is selected from the group of plastic materials comprising polytetrafluoroethyelene (TEFLON®) and a thermoplastic material containing ceramic particles.

8. A rotary thrust bearing assembly, comprising:
a first bearing housing adapted to be connected to a first component undergoing rotary movement, fabricated from a first plastic material, and defining a first substantially planar bearing surface;
a second bearing housing adapted to be connected to a second component undergoing rotary movement, fabricated from a second plastic material, and defining a second substantially planar bearing surface; and
a bearing insert fabricated from a third plastic material which is different from said first and second plastic, interposed between said first and second bearing surfaces of said first and second bearing housings, and comprising first and second substantially planar bearing surfaces so as to respectively define first and second bearing planes between said first planar bearing surfaces of said first bearing housing and said bearing insert, and between said second planar bearing surfaces of said second bearing housing and said bearing insert for facilitating rotational movement of said first and second bearing housings with respect to each other.

9. The rotary thrust bearing assembly as set forth in claim 8, wherein:
said first planar bearing surfaces of said first bearing housing and said bearing insert are disposed in surface-to-surface contact with each other along said first bearing plane, and said second planar bearing surfaces of said second bearing housing and said bearing insert are disposed in surface-to-surface contact with each other along said second bearing plane.

10. The rotary thrust bearing assembly as set forth in claim 8, wherein:
said first and second bearing planes are disposed substantially parallel with respect to each other.

11. The rotary thrust bearing assembly as set forth in claim 8, wherein:
said first bearing housing has a recessed portion defined therein; and
said bearing insert is disposed within said recessed portion of said first bearing housing.

12. The rotary thrust bearing assembly as set forth in claim 8, wherein:
said first and second plastic materials, from which said first and second bearing housings are fabricated, are the same.

13. The rotary thrust bearing assembly as set forth in claim 12, wherein:
said plastic material, from which both of said first and second bearing housings are fabricated, is selected from the group of plastic materials comprising NYLON®, an acetate, an ultra-high molecular weight (UHMW) polyethylene, a polycarbonate, a polyamide, a polypropylene, and a polyester.

14. The rotary thrust bearing assembly as set forth in claim 12, wherein:
said third plastic material, from which said bearing insert is fabricated, is selected from the group of plastic materials comprising polytetrafluoroethyelene (TEFLON®) and a thermoplastic material containing ceramic particles.

15. A rotary thrust bearing assembly, comprising:
a first bearing housing adapted to be connected to a first component undergoing rotary movement, fabricated from a first plastic material, and defining a first substantially planar bearing surface; and
a second bearing housing adapted to be connected to a second component undergoing rotary movement, fabricated from a second plastic material, and defining a second substantially planar bearing surface;
said first and second substantially planar bearing surfaces together defining a bearing plane for facilitating rotational movement therealong of said first and second bearing housings with respect to each other.

16. The rotary thrust bearing assembly as set forth in claim 15, wherein:
said first and second planar bearing surfaces of said first and second bearing housings are disposed in surface-to-surface contact with each other along said bearing plane.

17. The rotary thrust bearing assembly as set forth in claim 15, wherein:
said first bearing housing has a recessed portion defined therein; and
said second bearing surface of said second bearing housing is disposed within said recessed portion of said first bearing housing.

18. The rotary thrust bearing assembly as set forth in claim 15, wherein:
said first and second plastic materials, from which said first and second bearing housings are fabricated, are different from each other.

19. The rotary thrust bearing assembly as set forth in claim 18, wherein:
said plastic materials, from which either one of said first and second bearing housings are fabricated, is selected from the group of plastic materials comprising NYLON®, an acetate, an ultra-high molecular weight (UHMW) polyethylene, a polycarbonate, a polyamide, a polypropylene, and a polyester.
